(19) United States
(12) Patent Application Publication
(10) Pub. No.: US 2011/0308097 A1
(43) Pub. Date: Dec. 22, 2011

(54) CUTTING TOOL FOR THE SEVERANCE OF BOARD-LIKE WORKPIECES

(76) Inventor: Thomas Vollrath, Auggen (DE)

(21) Appl. No.: 13/055,537

(22) PCT Filed: Jul. 24, 2009
(86) PCT No.: PCT/EP09/59549

§ 371 Date: Feb. 28, 2011

(30) Foreign Application Priority Data
Jul. 25, 2008 (DE) 102008034675.6

(51) Int. Cl. B23D 29/02

(52) U.S. Cl. 30/388

(57) ABSTRACT

Cutting tool for the severance of board-like or web-like workpieces (P), in particular of building boards, floorboards, rigid or flexible material or the like, also as sheet or web material, with a counterbearing, particularly in the form of a support (1d), and with at least one circular cutting blade (2) which is mounted rotatably above the counterbearing (1d) by means of a holding arrangement (3), in such a way that, in use, teeth of the circular cutting blade (2) penetrate into the board-like workpiece (P) to be severed, and, during the rotation of the circular cutting blade (2; 20), push the workpiece (P) forwards along the at least one circular cutting blade (2; 20), while at the same time the workpiece is sheared off on the counterbearing (1d). The holding arrangement (3) is connected to the counterbearing (1d) such that the forces occurring during severance can be absorbed. The at least one circular cutting blade (2; 20) can be driven at low speed, preferably manually, for the rotation, so that, during the severing operation, the workpiece is at the same time automatically transported and pushed forwards by the teeth of the at least one circular cutting blade. The rotation of the circular cutting blade is in this case sufficiently slow to ensure that the material is “sheared off” on the teeth of the circular sawblade and is not chipped, as occurs, for example, in the case of a circular saw.

The invention relates to a cutting tool for the severance of board-like workpieces, in particular of building boards, floorboards, laminates, PVC, roofing felt or the like. The term “board-like” is in this context also to embrace “web-like” workpieces.

The invention relates particularly to such a device which is mobile and can be transported very simply, so that it can be used on the spot, for example on a building site, in interior work.

DE 202005010660 U1 discloses a transportable cutting tool for the cutting of board-like workpieces made from materials which are designated in the publication as “reconstituted” materials. This term designates there board-like building elements which are produced from powders, fibres, granules or chips composed of gypsum, cement, ceramic, cellulose, wood, etc. or from combinations and laminates and are used in the construction sector, particularly in interior work. This cutting tool comprises a plinth or base and a flat, curved blade which is mounted on the plinth so as to execute a pivoting movement. The blade is actuated manually by pressing down the blade and shearing off the board placed on the carrier. In order to prevent the board from slipping out of place during cutting on account of the curvature of the blade and the cutting movement, a stop is provided.

One problem of such cutting tools is that relatively high forces have to be applied in order to cut the board-like workpieces by means of the pivoting knife and, in principle, only straight cuts can be made through the entire workpiece. It is not possible at all, or at least not possible satisfactorily, to cut out clearances or notches from the surface of the board. Furthermore, there is a high risk of injury because of the relatively large blade exposed over a great length in the cutting region and because of the considerable actuating forces which have to be applied. Moreover, true wood, rigid or flexible material, even as web material, such as roofing felt or bitumen sheets, cannot be cut in a practicable way on account of the strength or toughness and because of the large dimensions where sheet or web material is concerned.

The object of the invention is to provide an improved mobile cutting tool for the severance of board-like workpieces, in particular of building boards of the type described above, and here especially preferably, of floorboards (true wood or laminates) and of rigid or flexible material, such as PVC, roofing felt, etc., also as sheet or web material, on the spot, which eliminates at least some of the disadvantages of the prior art.

To achieve this object, the invention proposes a cutting tool for the severance of board-like workpieces, having the features of Patent Claim 1. Preferred embodiments are specified in the dependent claims.

The cutting tool according to the invention uses as a severing tool at least one circular cutting blade which is mounted rotatably on a holding arrangement via a stable counterbearing, preferably a supporting surface, and which can be driven at low speed, preferably manually, in order to rotate it. During rotation, the teeth of the at least one circular cutting blade penetrate into the board-like workpiece to be severed, and, during the rotation of the circular cutting blade, the workpiece is pushed forwards along the circular cutting blade, while at the same time the workpiece is sheared off by the teeth of the circular cutting blade on the counterbearing.

Manual drive can be effected in a simple way, for example, by means of a long hand-operated lever arm or a crank, with relatively low manually applicable force being sufficient to sever the workpiece on account of the high lever ratio between the cutting length at the individual cutting teeth and the length of the lever arm. During the severing operation, the workpiece is at the same time automatically transported and pushed forwards by the teeth of the circular cutting blade. The rotation of the circular cutting blade is in this case sufficiently slow to ensure that the material is “sheared off” on the teeth of the circular sawblade and is not chipped, as occurs, for example, in the case of a circular saw. Furthermore, as a result, neither dust nor noise arises during operation.

In comparison with the known pivoting knife, the workpiece is not pressed out of the severance zone during the severing operation, and therefore, on the one hand, there is no need for a stop, and, on the other hand, virtually continuous cuts, without the cutting length being limited, are possible at any angle in the cutting plane.

To reduce the actuating forces and to improve the severing operation, a double circular cutting blade with two coaxial circular cutting blades spaced apart from one another has proved to be especially advantageous, because linear transport or advance is thereby achieved by means of two parallel spaced-apart engagement points for cutting or shearing forces and for advancing forces.

The invention is explained in more detail below by means of preferred embodiments, with reference to the accompanying drawing in which:

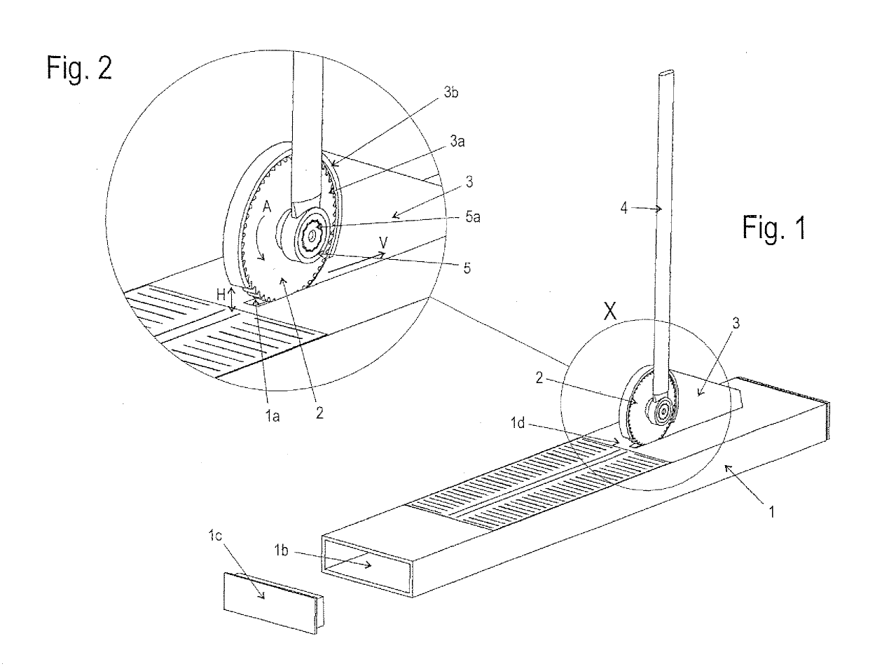

FIG. 1 shows a perspective illustration of a cutting tool for manual drive;

FIG. 2 shows an enlarged illustration of the circular cutting blade within the detail X of FIG. 1;

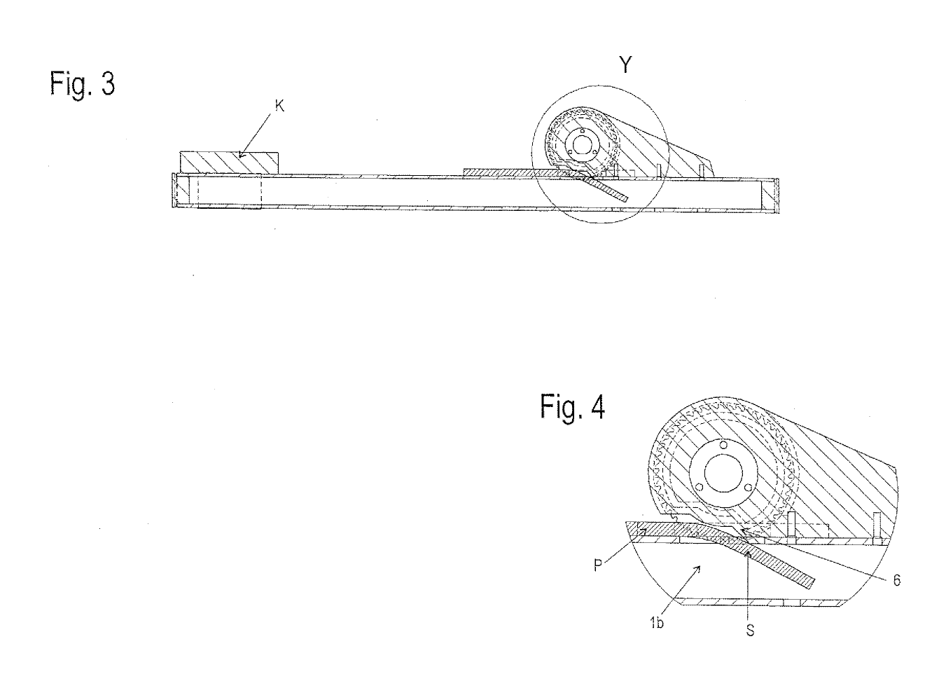

FIG. 3 shows a partially sectional side view of the cutting tool of FIG. 1;

FIG. 4 shows an enlarged illustration of the circular cutting blade within the detail Y of FIG. 3;

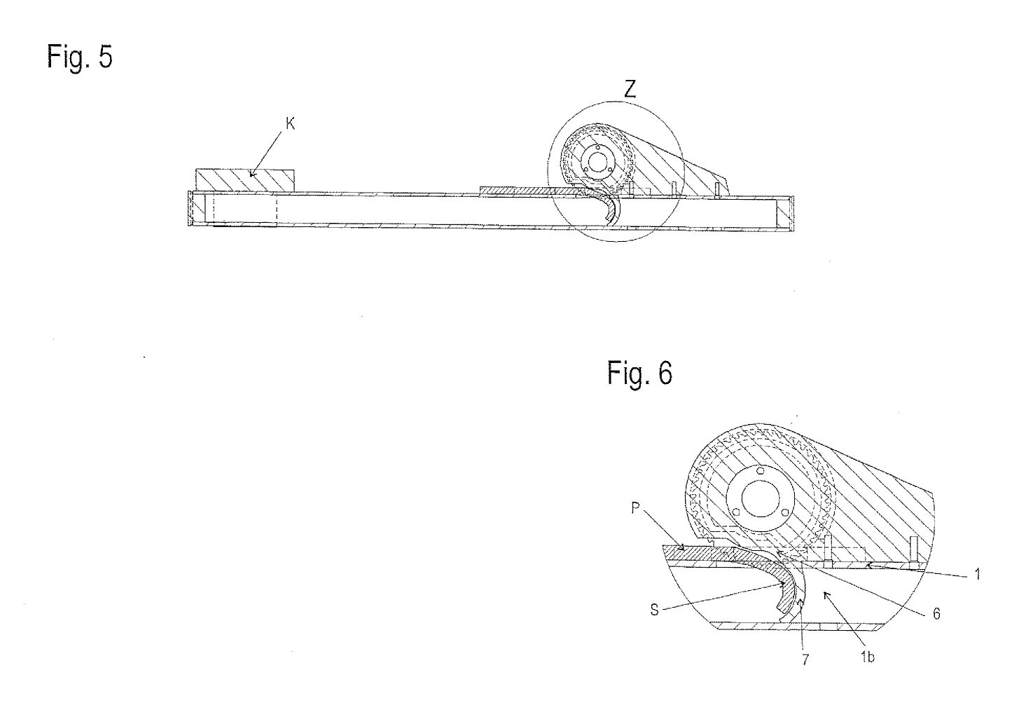

FIG. 5 shows a partially sectional side view of a cutting tool which is modified in relation to the embodiment of FIG. 3;

FIG. 6 shows an enlarged illustration of the circular cutting blade within the detail Z of FIG. 5;

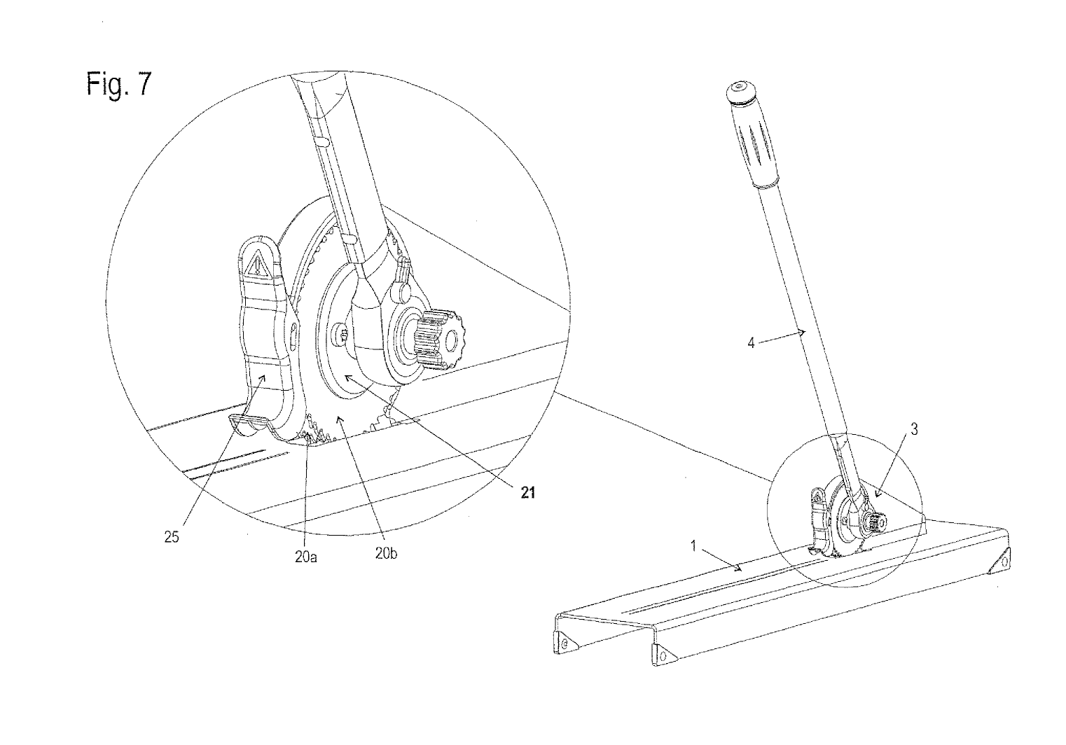

FIG. 7 shows a perspective view of a cutting tool according to the invention in a modification, with an enlarged illustration of a detail relating to the design of the circular cutting blades;

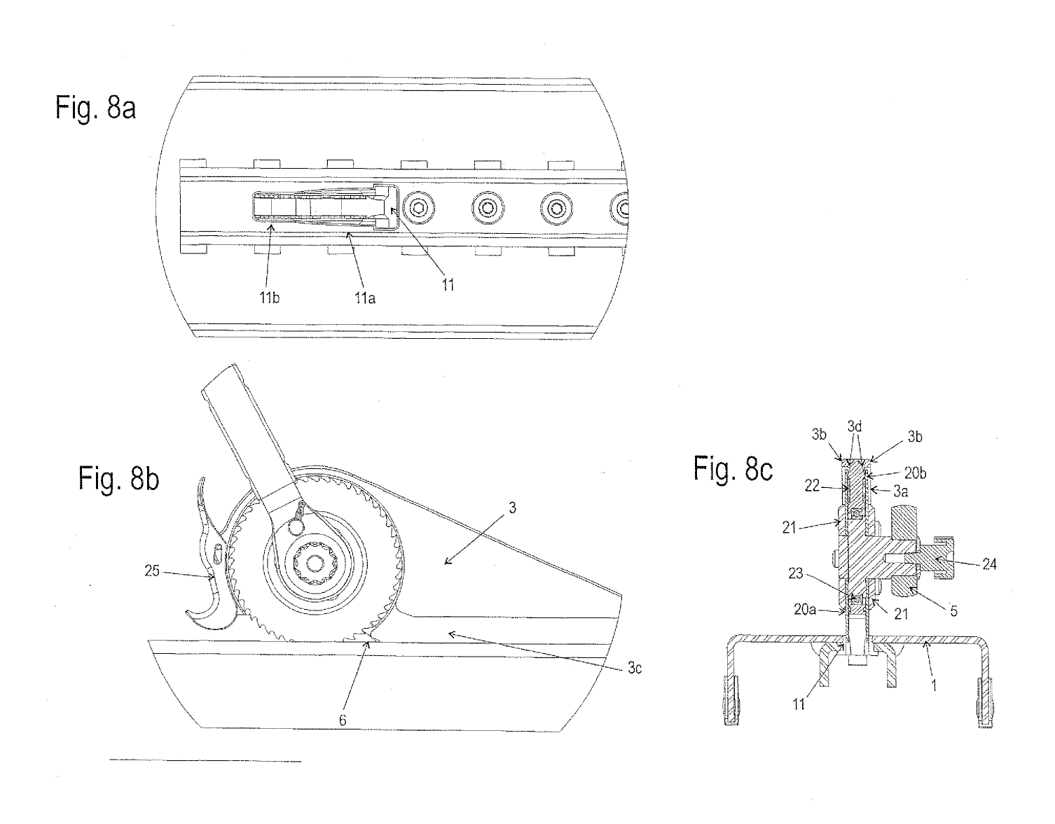

FIGS. 8a, b and c show partially sectional views of the cutting tool according to the invention, as shown in FIG. 7, in order to make clear individual structural details;

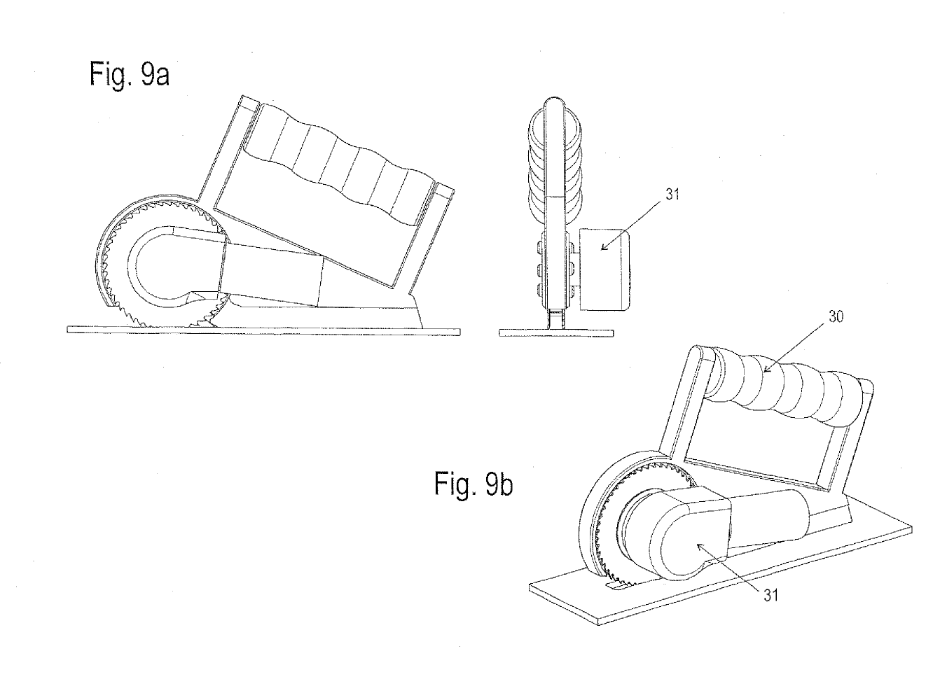

FIGS. 9a and b show views of a hand-held motorized embodiment of the cutting tool according to the invention; and

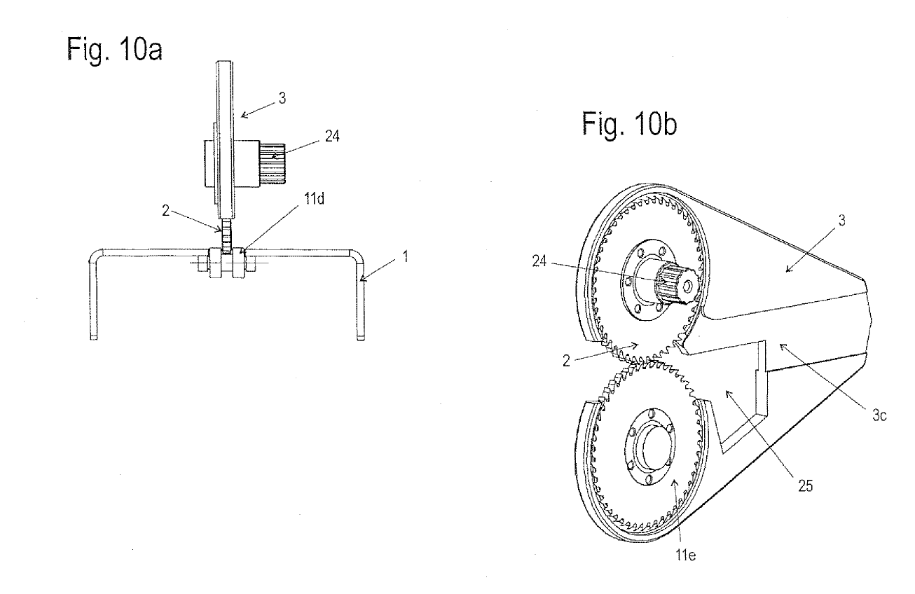

FIGS. 10a and b show views of further embodiments of the cutting tool according to the invention, in which the counterbearing is formed by a counter roller or a further circular cutting blade, FIG. 10a being a partially sectional view and FIG. 10b being a perspective view.

The cutting tool according to the invention for the severance of board-like workpieces, such as fibreboards, floorboards (true wood or laminate), rigid or flexible material (for example, roofing felt, PVC), etc., also as sheet or web material, such as are described in the description introduction in connection with DE 202005010660 U1, comprises, according to the illustration in FIGS. 1 and 2, a stable frame part 1, on which a circular cutting blade 2 is mounted rotatably via a shaft on a holding arrangement 3 for rotation in the direction A about a centre-axis above a support 1d intended for the workpiece and serving as a counterbearing. In the working position of the cutting tool, the axis of rotation is preferably parallel to a supporting surface for the workpiece P to be severed.

The holding arrangement 3 is connected to the support 1d of the frame such that the forces occurring during shearing can be absorbed.

The mounting of the circular cutting blade 2 is selected such that, in use, teeth of the circular cutting blade 2 can penetrate into the board-like workpiece to be worked, and, during the rotation of the circular cutting blade 2 about the axis of rotation at low speed, the workpiece is pushed forwards through the circular cutting blade and along the circular cutting blade in the direction of advance V, while at the same time the workpiece is severed on the support. The support for the workpiece may be formed in the region of the circular cutting blade 2 by a supporting region 1d of the frame part 1. The circular cutting blade is in this case arranged such that, during the rotation, the teeth of the circular cutting blade 2; 20 dip below the plane defined by the supporting surface of the support 1d.

The circular cutting blade 2 can be driven in slow rotation about the axis, a maximum rotational speed of a few revolutions per second or less, preferably a rotational speed corresponding to normal intermittent hand operation being sufficient and especially suitable. Speeds of less than 10 revolutions per second, preferably of less than 5 revolutions per second and, further preferably, of less than 1 revolution per second are preferred.

Manual drive is therefore especially preferable and is indicated in the embodiment illustrated. For this purpose, for example, an extension 5a or a recess with one or more faces for the positive transmission of forces/torques (for example, as inner or outer two-edged, square, hexagonal or multi-toothed profile) is provided in the region (preferably coaxially with the axis of rotation of the circular cutting blade 2), so that a conventionally functioning ratchet with a ratchet mechanism 5 and lever arm 4 for positive torque transmission can be attached externally and preferably releasably. A non-positive (force-fit) connection may likewise be used.

The advantage of the ratchet mechanism or pawl drive is that the force for rotating the circular cutting blade can always be exerted in the same region of movement, and a reversal in direction of rotation by means of a changeover lever or by the mirror-inverted attachment of the ratchet mechanism is possible in a simple way. A change in the direction of rotation makes it easier to move the cut material back when partial-cuts are to be made in the material, that is to say when the material is not to be severed completely. Furthermore, ratchets with different lever arms are commercially available, make it possible to have a cost-effective set-up and, in so far as they are sufficiently stable, are sometimes present in the tool field. They can be used very conveniently, since a complete revolution about the axis of rotation is not necessary, and the operating travel can be placed into an “easy-to-handle” region, the operating travel is subdivided into a large number of small ergonomic angular movements, and the effort exerted may be insignificant.

In an alternative embodiment, the ratchet mechanism 5 for driving the circular cutting blade may also be integrated into the cutting tool itself, for example in the region of the axis of rotation. For the simple transport of the tool, at least the lever arm 4 may be provided so as to be removable.

In order to increase the force or the torque applied to the teeth of the circular cutting blade, a gear arrangement between the drive and the circular cutting blade may be provided, if required.

For example, non-interleaved standard circular saw blades having the most diverse possible tooth geometries, which are readily available commercially, may be used for the circular cutting blade to be employed in the cutting tool according to the invention. The circular cutting blade (width, tooth form, diameter, material) may be selected as a function of the materials to be severed. It is important, above all, that the tooth form is selected such that the force to be applied by hand is sufficient to drive the teeth into the material and to shear it off.

In a preferred embodiment, at least some of the teeth, preferably all the teeth, are configured such that their tips are directed and project in the direction of rotation during the cutting operation, although this form is not absolutely necessary. It must be ensured by the teeth of the circular cutting blade that the workpiece is not only severed or sheared off, but at the same time pushed on the support, that is to say pushed forwards or pressed towards the severing tool, and is transported along the side flanks of the cutting blade or cutting blades and, further on, along the holding arrangement 3. The advancing speed consequently corresponds essentially to the circumferential speed, because both result from the drive force and, in normal operation, only insignificant slip occurs between the workpiece and the cutting blade, because ideally, but not necessarily, one tooth or a plurality of teeth is or are always in advancing engagement.

What is especially preferred for reducing the actuating forces and for improving the severing operation is a multiple, preferably double cutting blade 20 with two, preferably coaxial circular cutting blades spaced apart from one another (see, for example, the illustration of the modified embodiment according to FIGS. 7 and 8). In this multiple cutting blade, the cut material is transported away, free of faults, from the cutting zone through the interspaces between the individual circular cutting blades 20a, 20b, if appropriate also assisted by the friction against the inner flanks. When this multiple cutting blade is used, the cut material is in the form of a chip S, as indicated in FIG. 4. In the cutting tool according to the invention, even more than two such preferably coaxial circular cutting blades may be provided.

In the support for the workpiece, an elongate recess 11 is provided, into which the circular cutting blade 2 or circular cutting blades 20a, 20b (when a multiple cutting blade 20 is used) projects or project at least to an extent such that their tooth bottom lies below the supporting plane of the cut material on the supporting surface. The recess is approximately rectangular in a top view, the longitudinal edges of the recess 11 having, in a region 11b, at the front in the direction of advance, at the run-in of the workpiece, a small spacing from the outer side faces of the circular cutting blade 2 or circular cutting blades 20a, 20b, in order to make it easier to shear off the workpiece at these edges, and the spacing towards a rear region 11a widening somewhat in the direction of advance, in order to make it easier to discharge the severed material strip, particularly in the case of fraying material. As seen in the direction of the illustration of FIG. 8c, the longitudinal edges may also run outwards or widen from the top side of the support towards an underside.

The circular cutting blade 2, 20 itself or the circular cutting blades themselves is/are mounted preferably releasably for the purpose of exchange. In a modification, not illustrated, the extension for attaching the lever or ratchet mechanism 4 may be provided selectively on the left or the right side or else on both sides of the cutting tool, in order to enable right-handed and left-handed persons to operate the device. In order to prevent an unintentional release of the ratchet mechanism/lever 4, a holding nut 24 or a holding screw or a clamping or locking mechanism (not illustrated) may be provided, as indicated in FIGS. 7 and 8c.

The holding arrangement 3 for the circular cutting blade 2 has, behind the circular cutting blade 2 in the direction of advance, a guide portion 3c for the workpiece P. This portion is of the same width as or is preferably slightly narrower than the cutting width of the circular cutting blade 2, 20, so that the workpiece P can pass on both sides in the direction of advance, and therefore tilting of the workpiece is avoided and a straight cut is possible. Since the holding arrangement 3 is arranged only in the region behind the cutting blade and projects from the frame part 1, it is possible to cut “continuous” lengths of material (for example, of sheet or web material), without any width limitation.

For protection against injuries and in order to make it easier to strip off material possibly adhering to the teeth of the cutting blade, the holding arrangement 3 has on one side, or preferably on both sides, a recess or depression 3a in which the cutting blade 2 lies or the cutting blades 20a, 20b in the case of a double cutting blade lie, so that a peripheral projection 3b is formed on the circumference of each depression 3a (see FIGS. 2 and 8c). By suitable choice of the vertical height H of the margin formed by the projections 3b at the run-in into the cutting blade, the material thickness can be limited, and thicker material which cannot be cut then butts against the margin and cannot be introduced into the cutting region. The projection may also engage over the cutting blade in portions, in particular on the top side, in order to protect against injuries.

In the case of a double cutting blade 20, as is shown especially clearly in FIG. 8c, the inner faces of the two circular cutting blades 20a, 20b are supported on faces in the depressions 3a, in order to transmit transverse forces to the holding arrangement 3, to avoid deformation of the cutting blades and to relieve the radial bearing 23 of transverse forces. Sliding elements 22, for example in the form of sliding washers or rings or strips, may be introduced into the depressions, the faces of which sliding elements bear against the inner faces of the cutting blades and preferably lower friction to an amount such that only an inherent rotation of the cutting blades under the action of the dead weight of the lever is avoided. Alternatively or additionally, inner faces of the depressions may also be segmented and/or coated with a friction-reducing or wear-reducing material.

On the outside of the cutting blades, supporting discs 21 may be arranged, which reduce or prevent deformation of the cutting blades in the transverse direction.

In the region of the projections 3b, in each case a peripheral groove 3d for chip discharge may be provided in the depressions in the region of the teeth of the respective circular cutting blade (20a; 20b) (see FIG. 8c), these grooves being discontinuous or closed in the region of the run-in, in order to prevent chips from being introduced into the grooves, and being open at the run-out, in order to make it easier to discharge the chips.

In the rear region of the cutting blade or behind the cutting blade, a type of chip guide 6, 7 may be provided on the holding arrangement 3 or the frame part 1 and preferably has an oblique or arcuate form and deflects the detached or separated-out material strip S downwards into a region 1b below the supporting region (see FIGS. 4 and 8b). Alternatively, in a variant, a finger reaching into the interspace between the cutting blades may be provided, in order to strip out cut material S located there, for example sheared-off chips or separated-out material, in any form and to deflect it into the region below the support. For the further improvement in the deflection of the cut material S and to make it easier to break it into smaller segments, a sharper deflection 7 for the cut material S may be provided in a further embodiment which is indicated in FIGS. 5 and 6.

The region below the support may be open or may be designed as a cavity in which the cut material S can be collected. The cavity is accessible on one side or a plurality of sides or at the bottom and can be closed by means of an openable cover (only an end cover 1c is shown by way of example). Cut material S can be emptied, after working, by removing the cover. Alternatively, a trough (not illustrated) may be arranged removably under the support, for example in the cavity, which trough receives the cut material S and makes emptying simpler. The cavity or the trough arranged in it or under the support may in this case not only serve for receiving the cut material S during working, but may also receive and accommodate the external components of the cutting tool which are attached to the frame part 1, in particular the holding arrangement 3 with the circular cutting blade 2 and, if appropriate, the ratchet mechanism 5 with the lever arm 4, in so far as these are removable from the frame part 1, so that the entire appliance can be transported and stored in a space-saving way.

The frame part 1 may be designed, for example, as an extruded hollow profile, as illustrated in FIGS. 1 to 6, or as a U-profile in the form of an extruded profile or a welded or bent part made from sheet metal material, as illustrated in FIGS. 7 and 8. The external components of the cutting tool are attached preferably releasably to this frame part. Subsidiary lines, if appropriate with scaling, may be applied to the top side of the frame part by printing, engraving, lacquering or gluing and facilitate introduction, alignment and the dimensioning of cutting lengths.

According to FIG. 8b, a mechanical protection arrangement 25 may be provided on the run-in side of the cutting blade 2, 20. The protection arrangement is pivotable and is displaceable vertically, in order to be adapted to different material thicknesses and unevennesses of the cut material and at the same time not to impede or inhibit the advance. The actual configuration of the protection arrangement may per se be of any desired type.

Although the especially preferred embodiment of the cutting tool according to the invention can be driven manually, for example by a lever or a ratchet 4 of reversible blocking/direction of rotation or a hand-operated crank, according to a modification illustrated in FIG. 9 a very slow-running drive with a motor, if appropriate with a reduction gear and preferably reversible, may also be provided.

FIGS. 9a and 9b illustrate by way of example various views of such a hand-held motorized embodiment of the cutting tool according to the invention. 30 designates a handle which is arranged on the top side of the holding arrangement for the circular cutting blade and it is attached to this. The handle may also be attached to the support. In use, the tool can be held by the handle 30 and moved in order to control the cut. For simpler handling, the support 1d is designed as a relatively short plate. A motor gear unit which serves as a drive for the circular cutting blade is indicated at 31. The other design features are essentially the same as in the other embodiments, and there is therefore no need to describe them here. The circular cutting blade indicated is a double circular cutting blade. In the motorized variant, too, a single circular cutting blade may be used.

In FIGS. 3 and 5, a knee support K is indicated diagrammatically in the left-hand region and may optionally be provided on the frame and is especially advantageous in those cutting tools which are to be employed on the ground, for example on building sites.

In the exemplary embodiments described above, the counterbearing for the shearing operation by means of the circular cutting blade is formed by the supporting surface 1d in which is provided the recess 11 into which the at least one circular cutting blade 2; 20 projects and on the edge of which the workpiece is supported in order to be sheared off. However, according to the further embodiments illustrated diagrammatically in FIGS. 10a and 10b, the counterbearing may alternatively be formed by a counter wheel 11d arranged under the at least one circular cutting blade or by at least one further circular cutting blade 11e, with which the at least one circular cutting blade 2; 20 arranged above it cooperates in order to shear off the workpiece. The counter wheel 11d or the at least one further circular cutting blade 11e is mounted rotatably about an axis preferably parallel to the axis of the circular cutting blade 2.

If a further circular cutting blade 11e is used, which, if appropriate, may also be a double or multiple circular cutting blade, preferably with the same configuration as the circular cutting blade 2 described above, the cutting blades are arranged such that the teeth on the outer circumference are in engagement with one another for a short distance, so that the workpiece is sheared off between the circular cutting blades. In this case, the circular cutting blade or circular cutting blades 11e acting as a counterbearing may be driven directly or not be driven (that is to say, it is then, where appropriate, set in rotation by the other circular cutting blade). In one region behind and below the engagement region, a recess 25 in the holding arrangement 3 is provided, which makes it easier to discharge the cut material.

The counter wheel 11d illustrated in FIG. 10a has two spaced-apart discs or radial projections, between which the teeth of the at least one circular cutting blade 2 project. When a multiple circular cutting blade with axially spaced-apart circular cutting blades is used, correspondingly further discs or radial projections are provided.

In the embodiments according to FIGS. 10a and 10b, the counter wheel or the at least one further circular cutting blade 11e may also be mounted on the holding arrangement 3, and large-area support for the workpiece may, if appropriate, be dispensed with entirely (see FIG. 10b). Such a cutting tool can be used in an especially variable and versatile way on account of the smaller dimensions. Moreover, in these variants, all the features described above, such as a frame 1 (as indicated in FIG. 10a), a manual or a motive drive according to all the variants described, an additional handle, etc., may also be provided.

1. Cutting tool for the severance of board-like workpieces (P), with
a counterbearing (1d) and at least one circular cutting blade (2) which is mounted rotatably above the counterbearing (1d) by means of a holding arrangement (3), in such a way that, in use, teeth of the circular cutting blade (2) penetrate into the board-like workpiece (P) to be severed, and, during the rotation of the at least one circular cutting blade (2; 20), push the workpiece (P) forwards along the at least one circular cutting blade (2; 20), while at the same time the workpiece is sheared off on the counterbearing (1d),
wherein the at least one circular cutting blade (2; 20) is drivable at low speed for the rotation, and
wherein the holding arrangement (3) is connected to the counterbearing (1d) such that the forces occurring during the severance can be absorbed.

2. Cutting tool according to claim 1, wherein during the rotation the teeth of the at least one circular cutting blade (2; 20) dip below a plane defined by supporting points of the counterbearing (1d) for the workpiece.

3. Cutting tool according to claim 1, wherein the circular cutting blade (2) is designed as a multiple cutting blade with at least two preferably coaxial circular cutting blades (20a, 20b) spaced apart from one another.

4. Cutting tool according to claim 1, wherein the at least one circular cutting blade (2; 20) is drivable for rotation at a speed of less than 10 revolutions per second.

5. Cutting tool according to claim 1, wherein an extension (5a) or a recess is provided for the preferably releasable and preferably positive attachment of a ratchet mechanism (5) or a crank, in each case preferably with a lever arm (4), for driving the at least one circular cutting blade (2; 20).

6. Cutting tool according to claim 1, wherein the cutting tool has integrated in it a/the ratchet mechanism (5) for driving the at least one circular cutting blade (2; 20).

7. Cutting tool according to claim 1, wherein a gear arrangement is provided for driving the at least one circular cutting blade (2; 20).

8. Cutting tool according to claim 1, wherein a chip guide (6, 7) is provided in order to deflect a sheared-off chip (S) away from the at least one circular cutting blade (2; 20).

9. Cutting tool according to claim 3, wherein the holding arrangement (3) has on both sides depressions in which the circular cutting blades (20a; 20b) are arranged, and/or side faces of the circular cutting blades (20a; 20b) are supported on faces in the depressions in order to transmit transverse forces.

10. Cutting tool according to claim 9, wherein groove (3d) for chip discharge is provided in the depressions in the region of the teeth of the respective circular cutting blade (20a; 20b).

11. Cutting tool according to claim 1, wherein the holding arrangement (3) has, behind the at least one circular cutting blade (2; 20) in the direction of advance, a guide portion (3c) for the workpiece (P) which is of the same width as or is narrower than the cutting width of the at least one circular cutting blade (2; 20) and causes the workpiece (P) to pass in the direction of advance.

12. Cutting tool according to claim 1, wherein the counterbearing is formed by a support (1d) in which is provided a recess (11) into which the at least one circular cutting blade (2; 20) projects.

13. Cutting tool according to claim 12, wherein the edges of the recess (11) have a small spacing from side faces of the at least one circular cutting blade (2; 20) in a region (11b), in front in the direction of advance, at the run-in of the workpiece, in order to make it easier to shear off the workpiece, and the spacing from a rear region (11a) is capable of widening in the direction of advance.

14. Cutting tool according to claim 12, wherein the support (1d) is part of a frame part (1) which is open or has a cavity (1b) in which chips (S) can be collected, a trough for receiving the chips (S) being inserted removably preferably under the support and/or into the cavity, or the cavity being accessible through an openable cover.

15. Cutting tool according to claim 1, wherein the counterbearing is formed by a counter wheel (11d), with which the at least one circular cutting blade (2; 20) cooperates for shearing off the workpiece.

16. Cutting tool according to claim 1, wherein the at least one circular cutting blade (2; 20) is drivable for rotation at low speed manually or by means of a motorized drive.

17. Cutting tool according to claim 13, wherein the support (1d) is part of a frame part (1) which is open or has a cavity (1b) in which chips (S) can be collected, a trough for receiving the chips (S) being inserted removably preferably under the support and/or into the cavity, or the cavity being accessible through an openable cover.

18. Cutting tool according to claim 4, wherein the at least one circular cutting blade (2; 20) is drivable for rotation at a speed of less than 5 revolutions per second.

19. Cutting tool according to claim 18, wherein the at least one circular cutting blade (2; 20) is drivable for rotation at a speed of less than 1 revolution per second.
